(19) United States
(12) Patent Application Publication
(10) Pub. No.: US 2006/0269718 A1
(43) Pub. Date: Nov. 30, 2006

(54) Optical disk

(75) Inventor: Toshimori Miyakoshi, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/435,863

(22) Filed: May 18, 2006

(30) Foreign Application Priority Data
May 31, 2005 (JP) 2005-159058

(51) Int. Cl. B32B 3/02

(52) U.S. Cl. 428/64.4

(57) ABSTRACT

Provided is an optical disk including: a substrate; a reflective layer laminated on the substrate; a recording layer laminated on the reflective layer; and a buffer layer formed between the substrate and the reflective layer, the buffer layer having a thermal conductivity lower than that of the reflective layer. The optical disk suppresses the deformation of the substrate due to heat or a stress caused upon film formation or by, for example, repeated recording and reproduction operations, and which is excellent in long-term stability.

### BACKGROUND OF THE INVENTION

1. Field of the Invention

The present invention relates to a read only type optical disk capable of reproducing information through irradiation with light, a write-once read-many type optical disk capable of recording and reproducing information through irradiation with light or heating, and a phase-change type or magneto-optical type rewritable optical disk capable of recording, reproducing, and erasing information through irradiation with light or heating.

2. Related Background Art

In accordance with the digitalization of a dynamic image, there has been a growing demand for an increase in recording density of a recording medium to provide a large-capacity recording medium in recent years. To cope with the demand, a non-contact optical disk having a larger recording density than that of a magnetic recording medium that has been conventionally used has been vigorously researched and developed. Several kinds of optical disks are available. For example, the optical disks are roughly classified into: a read only type optical disk capable of only reading information; a write-once read-many type optical disk capable of only recording and reproducing information; and a rewritable optical disk capable of recording, reproducing, and erasing information.

The rewritable optical disks are mainly classified into a magneto-optical type optical disk and a phase-change type optical disk. The former disk records or erases information on the basis of the following fact. A magnetic film is irradiated with laser light, and the temperature of a portion irradiated with laser light increases, so a coercive force reduces. As a result, magnetization is easily inverted. Information is reproduced by means of the rotation of a polarization plane occurring when light is linearly polarized, and is reflected on or transmitted through the surface of the magnetic film, that is, a Kerr effect or a Faraday effect.

Meanwhile, the phase-change type optical disk records and erases information on the basis of the following fact. When a material mainly composed of, for example, a chalcogen element is irradiated with laser light, and the temperature of the material is heated to the melting point of the material or higher and then quenched, the material is in an amorphous state. When the temperature of the material is heated to a temperature between the crystallization temperature of the material and the melting point, the material is in a crystalline state. In addition, the phase-change type optical disk reproduces the information by means of a difference in reflectivity between the amorphous state and the crystalline state.

Out of the rewritable optical disks, a phase-change type optical disk generally has a structure obtained by: providing a first protective layer composed of ZnS, ZrO₂, or SiO₂ on a substrate composed of polycarbonate (PC), an epoxy-based resin, an acrylic resin (PMMA), or the like; forming a recording layer on the first protective layer; and providing a second protective layer composed of the same substance as that of the first protective layer on the recording layer (an additional organic protective layer is laminated on the second protective layer in some cases).

A material to be used in the recording layer is requested to crystallize quickly, to maintain an amorphous state stably for a long time period, and to maintain operating characteristics stably even when the number of rewriting increases. For example, an In—Sn-based, Ge—Sb—Te-based, Ge—Te-based, Sn—Te-based, or Te—O—Sn—Ge-based material is used. Each of the protective layers improves the weatherability of the recording layer such as oxidation resistance, and secures long-term stability. In addition, as described above, ZnS₂, ZrO₂, or SiO₂ is used in each of the protective layers because each of the protective layers preferably has a large adiabatic effect in such a manner that the recording layer can be efficiently heated.

Optical pickups are used for recording/reproducing signals on/from those optical disks. In order that light may be accurately converged on a recording surface, a servo is applied to an optical pickup so that the optical pickup can follow the waviness of the recording surface. As a result, the accuracy of position of the optical pickup with respect to the recording surface is secured.

In addition, in general, the recording density of an optical disk largely depends on the laser wavelength of a reproduction optical system and the numerical aperture NA of an objective lens. That is, when the laser wavelength λ of the reproduction optical system and the numerical aperture NA of the objective lens are determined, a diameter of a beam waist is also determined. Accordingly, the spatial frequency of a recording pit capable of signal reproduction is at most about 2NA/λ. Therefore, the laser wavelength λ of the reproduction optical system must be shortened, or the numerical aperture NA of the objective lens must be increased so that an increase in density of an optical recording medium can be realized.

However, when the numerical aperture NA of the objective lens is increased, the thickness of a portion irradiated with reproduction light and through which the reproduction light transmits must be reduced. This is because the tolerance of an aberration occurring owing to an angle by which a disk surface deviates from a vertical direction with respect to the optical axis of an optical pickup (a so-called tilt angle which is proportional to the square of the product of the inverse number of the wavelength of a light source and the numerical aperture of the objective lens) reduces in accordance with an increase in NA, and the tilt angle is susceptible to the aberration due to a thick substrate. Therefore, the thickness of the substrate is reduced so that an influence of the aberration on the tilt angle is reduced to the extent possible.

On the other hand, the responsiveness of servo control for the position of the optical pickup is limited, so it is difficult to control the above position accurately with desired accuracy. Accordingly, a variation in thickness of the portion through which the reproduction light transmits must fall within a predetermined range.

However, an additional increase in recording density will be required in the future. Accordingly, an additional reduction in thickness of a substrate will be needed. In view of the foregoing, for example, the ideas described below such as the expansion of a tilt margin have been proposed. In a proposed read only type optical disk, irregularities are formed on one main surface of a substrate to serve as a recording layer. A reflective film is provided on the recording layer. A light transmission layer of a thin film through which light transmits is provided on the reflective film. Reproduction light is irradiated from the side of the light transmission layer so that the information in the recording layer is reproduced. In a proposed write-once read-many type or rewritable optical disk, a reflective film is provided on one main surface of a substrate. An organic pigment film, a phase-change film, or a magneto-optical recording film is formed on the reflective film to serve as a recording layer. A light transmission layer of a thin film through which light transmits is provided on the recording layer. Reproduction light is irradiated from the side of the light transmission layer so that information is recorded/reproduced on/from the recording layer, or information is recorded on, reproduced from, or erased from the recording layer. With the ideas, a reduction in thickness of the light transmission layer can cope with an increase in NAa of the objective lens. It should be noted that such light transmission layer is generally formed of a UV curable resin composed of an acrylic polymer material or the like.

For example, an RAM type optical disk having a diameter of 12 cm (one surface) to realize a capacity of about 25 GB and capable of recording and reproduction has been developed as a direct extension of a DVD (see, for example, Proc. SPIE Optical Data Storage, Vol. 4342, pp 168 to 177). A violet laser diode (LD) having a wavelength of 405 nm, and an objective lens having a numerical aperture NA of 0.85 are applied to the optical pickup of the optical disk. The optical disk adopts the following structure: a recording information layer composed of a phase-change film, a reflective film, and the like is formed on a plastic substrate in which grooves (substrate convex portions) are formed at a track pitch (Tp) of 320 nm, and a light transmissive cover having a thickness of, for example, 0.1 mm is formed on the recording information layer.

Upon recording of digital information on the disk, a light beam from the side of the light transmissive cover is converged with the objective lens on the grooves (substrate convex portions) formed in the substrate while a high accuracy tracking servo is applied along the grooves. The phase-change film is caused to undergo a phase change by a thermal action provided by the light beam converged on the grooves, whereby a recording mark is formed. That is, pulse recording corresponding to a digital signal is performed so that a desired recording mark train is formed on the grooves.

Signal reproduction is performed by detecting the intensity of a reflected beam while tracking the recorded mark train similarly.

For example, when a mark is recorded according to an RLL (1, 7) modulation mode, the shortest mark length needed for securing a recording capacity of, for example, 25 GB is about 150 nm. In this case, a recording mark is formed on a groove projecting toward a light beam irradiation side, that is, a side close to the objective lens.

In addition, a light beam is tracked by adopting a push-pull detection mode using light diffracted at the grooves (substrate convex portions). A beam to be applied is converged on the central line of the above-described groove projecting toward the beam irradiation side. A push-pull signal caused by the positional shift of the beam is regarded as a tracking error signal. A tracking servo is applied by means of the signal.

In the above-described reproduction mode in which a light beam is incident from the side of the light transmissive cover, the order in which the respective layers constituting an optical disk are laminated is completely opposite to the conventional one. A reflective layer is formed on a substrate at first. As a result, upon formation of the reflective layer, or owing to, for example, repeated recording and reproduction operations, as shown in FIGS. 4A and 4B, the substrate deforms owing to, for example, heat or a stress. Accordingly, there arises a problem in that the initial properties and long-term stability of the optical disk deteriorate. FIG. 4A schematically shows the sectional shapes of concave and convex portions in an initial substrate, and FIG. 4B schematically shows the sectional shapes of the concave and convex portions in the substrate after the formation of a reflective layer. Here, the concave and convex portions of the substrate correspond to those in the case where the substrate on which an irregular surface is formed is seen from a surface side. For example, in Proc. SPIE Optical Data Storage, Vol. 4342, pp 168 to 177, a portion coming forward with respect to light incident from the side of the light transmissive cover is a convex portion, and a portion retracting backward is a concave portion.

The manner in which the substrate deforms is as described below. A convex portion is crushed from a horizontal direction as a result of the penetration of the edges of the substrate concave portions. In association with the crush, the taper angle of the side wall of the convex portion increases, so the shoulders of the convex portion tend to rise. The case where a reflective layer receiving a compressive stress is used is shown here. When a reflective layer receiving a tensile stress is used, the direction in which the deformation occurs differs, so the convex portion tends to be crushed in a longitudinal direction.

To be more specific, the thermal structure of the optical disk, the coverage property (substrate covering property) of each layer, and the like change owing to changes in, for example, a duty between a concave portion and a convex portion in the substrate, the taper angle of the side wall of a convex portion, a groove depth, and the flatness of a recording track. As a result, the following problem arises: in an optical disk using a phase-change type recording layer, cross-erase property, the corrosion resistance of each of a reflective layer and the recording layer, and durability against repeated recording and reproduction are adversely affected, and, in an optical disk using a magneto-optical recording layer, cross-write property and a recording and reproduction process itself are adversely affected. Of those adverse effects, an effect caused by the deformation of a substrate upon formation of a reflective layer is remarkable. To alleviate the effect, attempts (for example, the initial shape of the substrate is defined while the deformation of the substrate is taken into consideration in advance) have been made. However, the deformation of the substrate due to heat or a stress has poor reproducibility, and involves the emergence of a problem in that a production yield reduces.

### SUMMARY OF THE INVENTION

The present invention provides an optical disk including: a substrate; and a reflective layer formed on the substrate, which suppresses the deformation of the substrate due to heat or a stress caused upon film formation or by, for example, repeated recording and reproduction operations, and which is excellent in long-term stability.

To be specific, according to the present invention, there is provided an optical disk including: a substrate; a reflective layer laminated on the substrate; a recording layer laminated on the reflective layer; and a buffer layer formed between the substrate and the reflective layer, the buffer layer having a thermal conductivity lower than that of the reflective layer.

### BRIEF DESCRIPTION OF THE DRAWINGS

FIG. 1 is a schematic sectional view showing an embodiment of an optical disk according to the present invention;

FIG. 2 is a schematic sectional view showing an embodiment of the constitution of each of an upper dielectric layer and a lower dielectric layer in the embodiment of the optical disk according to the present invention;

FIG. 3 is a schematic sectional view showing another embodiment of the optical disk according to the present invention; and

FIGS. 4A and 4B are schematic sectional views for comparison between the sectional shape of a substrate and the sectional shape of the substrate after the formation of a reflective layer.

### DESCRIPTION OF THE PREFERRED EMBODIMENTS

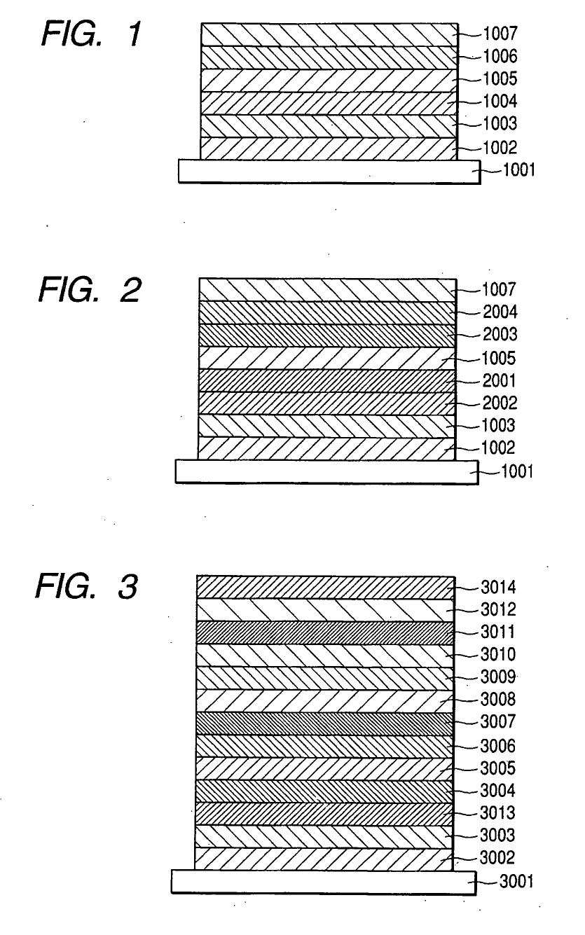

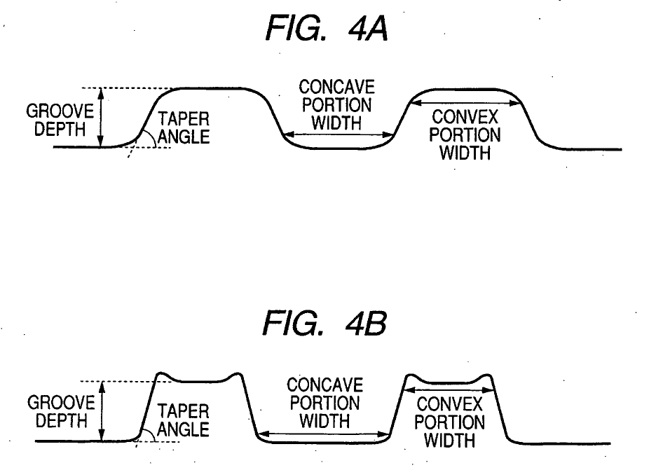

FIG. 1 is a schematic sectional view showing an embodiment of an optical disk according to the present invention. In this embodiment, a buffer layer 1002, a reflective layer 1003, a lower dielectric layer 1004, a recording layer 1005, an upper dielectric layer 1006, and a light transmissive cover layer 1007 are sequentially laminated on one main surface of a substrate 1001. In this case, the buffer layer 1002 preferably contains at least one dielectric material selected from the group consisting of SiO₂, Ta₂O₅, SiN, and SiC.

A first action as a result of the provision of the buffer layer 1002 between the substrate 1001 and the reflective layer 1003 as described above is considered to be as described below. The thermal conductivity of the buffer layer 1002 is smaller than that of the reflective layer 1003. As a result, it becomes possible to prevent the continued transfer of radiant heat from plasma upon formation of the reflective layer 1003 by means of a sputtering method to the substrate 1001 through the reflective layer 1003 being deposited, so the deformation of the substrate can be suppressed. In addition, a second action is considered to be as described below. The single, thin buffer layer 1002 is interposed between the substrate 1001 and the reflective layer 1003 having a large membrane stress (−2×10⁹ to −5×10⁹ dyne/cm²) on a compressive side, so an influence of the membrane stress of the reflective layer 1003 on the substrate 1001 is generally alleviated, and the deformation of the substrate can be suppressed.

Pit trains for information reproduction, or concave and convex portions (not shown) serving as guide grooves for guiding optical spots upon recording and reproduction of information are formed in the one main surface of the substrate 1001 on which the respective layers (commencing on the buffer layer 1002 and ending on the light transmissive cover layer 1007) are formed. The thickness of the substrate 1001 is preferably selected from the range of 0.3 mm to 1.2 mm, and is, for example, 1.1 mm.

Examples of a material to be used in the substrate 1001 include: a plastic material such as a polycarbonate-based resin, a polyolefin-based resin, or an acrylic resin; and glass.

A material for the buffer layer 1002 is selected in consideration of, for example, thermal conduction. That is, the material is selected from metal elements and semimetal elements each having a thermal conductivity lower than that of the reflective layer 1003 (for example, 4.0×10⁻² J/m·K·s (4.0×10⁻⁴ J/cm·K·s)), and compounds or mixtures of them. Specific examples of the material for the buffer layer 1002 include SiO₂, Ta₂O₅, SiN, and SiC. In addition, the thickness of the buffer layer 1002 is preferably selected from the range of 5 nm to the groove depth of the substrate (both inclusive), and is, for example, 10 nm. When the thickness of the buffer layer 1002 is 5 nm or more, the continuity of the layer is hardly lost, so an effect of the present invention is sufficiently exerted. In addition, when the thickness of the buffer layer 1002 is equal to or lower than the groove depth of the substrate, film coverage in imitation of the shape of the substrate can be easily obtained, so a thermal structure, corrosion resistance, and the like can be maintained.

A material for the reflective layer 1003 is selected in consideration of, for example, a reflection function and thermal conduction. That is, the material is selected from metal elements and semimetal elements each having a reflection ability with respect to the wavelength of laser light for use in recording and reproduction, and each having a thermal conductivity in the range of, for example, 4.0×10⁻² to 4.5×10² J/m·K·s (4.0×10⁻⁴ to 4.5 J/cm·K·s), and compounds or mixtures of them. Specific examples of the material for the reflective layer 1003 include: elements such as Al, Ag, Au, Ni, Cr, Ti, Pd, Co, Si, Ta, W, Mo, and Ge; and alloys each mainly composed of any one of these elements. Of those, an Al-based, Ag-based, Au-based, Si-based, or Ge-based material is preferable in consideration of practicability. Specific examples of a preferable alloy to be used as the material for the reflective layer 1003 include AlCu, AlTi, AlCr, AlCo, AlSi, AlMgSi, AgPdCu, AgPdTi, AgCuTi, AgPdCa, AgPdMg, AgPdFe, Ag, and SiB.

The thickness of the reflective layer 1003 is preferably selected from the range of 80 nm to 140 nm (both inclusive), and is, for example, 100 nm. When the thickness of the reflective layer 1003 is 80 nm or more, heat generated in the recording layer 1005 sufficiently diffuses, so heat cooling becomes sufficient. As a result, a problem, that is, a reduction in jitter property due to reproduction power upon reproduction hardly occurs. In addition, the fact that the thickness of the reflective layer 1003 may be 140 nm or less has practical meaning because the fact means that the thickness of the layer may be increased to the extent that heat and optical characteristics vary.

Each of the lower dielectric layer 1004 and the upper dielectric layer 1006 is constituted by, for example, laminating multiple dielectric layers. Each of the laminated dielectric layers is constituted by a material having a low absorption ability with respect to laser light for use in recording and reproduction, and is suitably constituted by a material the extinction coefficient k of which satisfies the relationship of 0<k≦3.

FIG. 2 shows an example of the constitution of each of the lower dielectric layer 1004 and the upper dielectric layer 1006. The lower dielectric layer 1004 is constituted by a first lower dielectric layer 2001 and a second lower dielectric layer 2002 preventing a reaction between the material constituting the first lower dielectric layer and the material constituting the reflective layer 1003. The upper dielectric layer 1006 is constituted by a first upper dielectric layer 2003 and a second upper dielectric layer 2004 preventing a reaction between the material constituting the first upper dielectric layer and the material constituting the light transmissive cover layer 1007. Each of the second lower dielectric layer 2002 and the second upper dielectric layer 2004 is composed of Si₃N₄. Each of the first lower dielectric layer 2001 and the first upper dielectric layer 2003 is composed of, for example, a ZnS—SiO₂ mixture, or preferably a ZnS—SiO₂ mixture having a molar ratio of about 4:1.

The thickness of the second lower dielectric layer 2002 is preferably selected from the range of 8 nm to 14 nm (both inclusive), and is, for example, 10 nm. When the thickness of the second lower dielectric layer 2002 is 8 nm or more, the diffusion of sulfur (S) as a material constituting the first lower dielectric layer 2001 can be suppressed, and the corrosion of the reflective layer 1003 can be prevented. In addition, when the thickness of the second lower dielectric layer 2002 is 14 nm or less, a reduction in reflectivity can be suppressed, and desired signal property can be obtained.

The thickness of the first lower dielectric layer 2001 is preferably selected from the range of 4 nm to 10 nm (both inclusive), and is, for example, 6nm. When the thickness of the first lower dielectric layer 2001 is 4 nm or more, the first lower dielectric layer 2001 having a uniform thickness can be easily formed. In addition, when the thickness of the first lower dielectric layer 2001 is 10 nm or less, a reduction in reflectivity can be suppressed, and desired signal property can be obtained.

The thickness of the first upper dielectric layer 2003 is preferably selected from the range of 4 nm to 12 nm (both inclusive), and is, for example, 6 nm. When the thickness of the first upper dielectric layer 2003 is 4 nm or more, the first upper dielectric layer 2003 having a uniform thickness can be easily formed. In addition, when the thickness of the first upper dielectric layer 2003 is 12 nm or less, heat is hardly accumulated in the recording layer 1005, so reproduction stability can be favorably maintained.

The thickness of the second upper dielectric layer 2004 is preferably selected from the range of 36 nm to 46 nm (both inclusive), and is, for example, 42 nm. When the thickness of the second upper dielectric layer 2004 is 36 nm or more, an increase in reflectivity can be appropriately suppressed. In addition, when the thickness of the second upper dielectric layer 2004 is 46 nm or less, a reduction in reflectivity can be appropriately suppressed.

The recording layer 1005 is a phase-change recording layer that records an information signal by means of a structural phase change from a crystalline phase to an amorphous phase. A chalcogen compound is preferably selected as a material for the recording layer 1005, and an SbTe-based alloy material is more preferably selected as the material. In particular, Ge, Sb, and Te are preferably selected for the SbTe-based alloy material. In this case, the Ge content is preferably selected from the range of 2 at. % to 8 at. % (both inclusive), and a ratio of Sb to Te is preferably selected from the range of 3.4 to 4.0 (both inclusive). The Ge content is more preferably selected from the range of 2 at. % to 8 at. % (both inclusive), and the ratio of Sb to Te is more preferably selected from the range of 4.2 to 4.8 (both inclusive).

The thickness of the recording layer 1005 is preferably selected from the range of 6 nm to 16 nm (both inclusive), and is, for example, 10 nm. When the thickness of the recording layer 1005 is 6 nm or more, sufficient reproduction durability can be obtained. In addition, when the thickness of the recording layer 1005 is 16 nm or less, recording sensitivity is improved, and an information signal can be favorably recorded.

The light transmissive cover layer 1007 is constituted by, for example, a light transmissive sheet (film) having a flat annular shape and an adhesive layer for sticking the light transmissive sheet to the upper dielectric layer 1006 (both not shown). The adhesive layer is composed of, for example, a UV curable resin or a pressure sensitive adhesive. The light transmissive sheet is preferably composed of a material having a low absorption ability with respect to laser light for use in recording and reproduction. To be specific, the sheet is preferably composed of a material having a transmittance of 90% or more. To be specific, the light transmissive sheet is composed of, for example, a polycarbonate resin material or a polyolefin-based resin. For example, when polycarbonate (PC) is used as the material for the light transmissive sheet, a material having a thermal expansion coefficient of about 7.0×10⁻⁵ (1/° C.) and a bending modulus of about 2.4×10⁴ (MPa) is used. In addition, when a polyolefin-based resin (such as a ZEONEX (registered trademark)) is used as the material for the light transmissive sheet, a material having a thermal expansion coefficient of about 6.0×10⁻⁵ (1/° C.) and a bending modulus of about 2.3×10⁴ (MPa) is used.

The thickness of the light transmissive sheet is preferably selected from the range of 3 μm to 177 μm (both inclusive), and is selected in such a manner that the total thickness of the sheet and the adhesive layer is, for example, 100 μm. A combination of the light transmissive cover layer 1007 having such thin thickness and an objective lens with NA as high as about 0.85 can realize high-density recording.

For example, the light transmissive sheet according to this embodiment is formed by: loading a material such as a polycarbonate resin into an extruder; melting the material at a temperature of 250 to 300° C. by means of a heater (not shown); molding the resultant into a sheet shape by means of multiple cooling rolls; and cutting the resultant into a shape conforming to the substrate 1001.

An additional protective layer composed of an organic or inorganic material may be formed for the purpose of preventing: the adhesion of dust to the surface of the light transmissive cover layer 1007; or any flaw in the surface. In this case as well, a material having substantially no absorption ability with respect to the wavelength of laser for use in recording and reproduction is desirable.

In the present invention, the kind and thickness of each of the recording layer, the reflective layer, the upper and lower dielectric layers, and the substrate are not particularly limited.

In addition, FIG. 3 is a schematic sectional view showing another embodiment of the optical disk according to the present invention. In this embodiment, a buffer layer 3002, a reflective heat sink layer 3003, a first dielectric layer 3013, an initialization layer 3004, a switching layer 3005, a writing layer 3006, an intermediate layer 3007, a memory layer 3008, a second switching layer 3009, a controlling layer 3010, a reproduction auxiliary layer 3011, a reproduction layer 3012, and a second dielectric layer 3014 are sequentially laminated on a substrate 3001.

A part ranging from the reproduction layer 3012 to the memory layer 3008 (D1/D2/C/Sr/M) constitutes a layer constitution for realizing reproduction according to a domain wall displacement detection (hereinafter referred to as DWDD) mode utilizing a domain wall displacement due to a temperature gradient (see, for example, Japanese Patent Application Laid-Open No. H06-290496). A part ranging from the memory layer 3008 to the initialization layer 3004 (M/Int/W/Sw/I) constitutes a layer constitution for realizing recording according to a domain tail erasing (hereinafter referred to as DTE) mode (see, for example, Japanese Patent Application Laid-Open No. H06-131722 and Japanese Patent Application Laid-Open No. 2000-25889). In the mode, a domain having a size enough to be stably recorded is formed by means of a light intensity modulation mode, and a domain tail is erased immediately after the formation to form a fine domain.

A switching layer that functions to switch the on and off of an interlayer exchange bond is present in each of both the DWDD and DTE constitutions, so the former switching layer is represented as an Sr layer and the latter switching layer is represented as an Sw layer for distinction.

For example, polycarbonate, acryl, glass, or the like can be used in the substrate 3001. A material such as SiN, AiN, SiO, ZnS, MgF, or TaO can be used in each of the first dielectric layer 3013 and the second dielectric layer 3014. A translucent material is not necessarily needed unless the displacement of a domain wall is optically detected.

This embodiment shows an example of the case where the reproduction auxiliary layer 3011 is provided from the viewpoint of an improvement in reproduction property, and an influence of a stray field on a domain wall displacement motion is suppressed in such a manner that saturation magnetization in the entire reproduction layer in a reproduction temperature range is cancelled. Alternatively, a composition gradient may be provided in a thickness direction, or a constitution with an increased number of layers may be used. A magnetic film composed of a GdFeCo-based material, or a GdDyFeCo-based material can be used.

The controlling layer 3010 suppresses a redundant domain wall displacement (ghost signal) at a rear end in a reproduction beam spot. A magnetic layer composed of a TbFeCo-based material or a TbDyFeCo-based material, or the like can be used in the layer.

The intermediate layer (Int) 3007 is intended for the adjustment of the intensity of an exchange interaction between the memory layer and the writing layer. A magnetic layer composed of a GdFeCo-based material can be used in the layer.

A material such as Al, AlTa, AlTi, AlCr, AlSi, Cu, Pt, or Au can be used in the reflective heat sink layer 3003.

A protective coat composed of a polymer resin may be provided. Alternatively, the substrate after film formation may be bonded. In addition, a layer except a magnetic layer is not indispensable, and the order in which magnetic layers are laminated may be inverted.

Each of those layers can be caused to adhere and formed by means of continuous sputtering, continuous deposition, or the like using, for example, a magnetron sputtering system. In particular, the respective magnetic layers are continuously formed without breaking a vacuum state, to thereby establish an exchange bond with each other.

In the above disk, each of the magnetic layers 3004 to 3012 is possibly constituted by any one of various magnetic materials such as a magnetic bubble material and an antiferromagnetic material as well as materials generally used in magnetic recording media and magneto-optical recording media. For example, each of the layer can be constituted by a rare earth-transition metal group amorphous alloy constituted by: 10 to 40 at. % of one or two or more kinds of rare earth metal elements such as Pr, Nd, Sm, Eu, Gd, Tb, Dy, Ho, and Er; and 90 to 60 at. % of one or two or more kinds of transition metal group elements such as Fe, Co, and Ni.

In addition, such alloy may be added with a small quantity of an element such as Cr, Mn, Cu, Ti, Al, Si, Pt, or In for, for example, an improvement in corrosion resistance. A platinum group-iron group periodic structure film such as Pt/Co or Pd/Co, a platinum group-iron group alloy film, an antiferromagnetic material such as a Co—Ni—O-based or Fe—Rh-based alloy, or a material such as magnetic garnet can also be used.

In the case of a heavy rare earth-iron transition metal group amorphous alloy, saturation magnetization can be controlled depending on a composition ratio between a rare earth element and a transition metal group element. Saturation magnetization at room temperature can be 0 emu/cc in the case of compensating composition. A Curie temperature can also be controlled depending on the composition ratio. In order that the Curie temperature may be controlled independent of the saturation magnetization, a method can be more preferably used, which involves: using a material obtained by substituting a part of Fe by Co as a transition metal group element; and controlling a substitution amount. That is, the substitution of 1 at. % of an Fe element by Co is expected to increase the Curie temperature by about 6° C. Accordingly, the amount of Co to be added is adjusted on the basis of the above relationship in such a manner that a desired Curie temperature is obtained. In contrast, adding a trace amount of a non-magnetic element such as Cr, Ti, or Al can reduce the Curie temperature. The Curie temperature can also be controlled by adjusting a composition ratio between two or more kinds of rare earth elements.

Particular attention should be paid to the setting of the Curie temperature of each of magnetic layers involved in a recording temperature, an erasing temperature, and an initialization temperature, that is, the W layer, the M layer, and the Sw layer in order to realize a process according to the DTE mode. A difference between any two of the temperatures is preferably as small as possible because the temperature of each magnetic layer is heated to the recording temperature, instantaneously cooled to the initialization temperature so that initialization is performed, and heated to the erasing temperature immediately after the initialization.

In an ordinary LIMDOW medium, upon formation of a temperature distribution at an erasing temperature level, the peak temperature of the distribution must not exceed a recording temperature, so a difference between the recording temperature and an erasing temperature must be large. In the case of the DTE mode, however, even when a domain is written at a central high-temperature portion at the time of an erasing operation, no problem arises because the domain can be overwritten in a subsequent recording or erasing operation. Therefore, the Curie temperature of the M layer can be set at a high temperature close to the Curie temperature of the W layer. For example, in a preferred embodiment, a difference between them is 50° C. or lower. In association with the setting, the Curie temperature of the Sw layer can also be set at a high temperature close to the Curie temperature of the M layer to the extent that the initialization of the W layer does not affect the magnetization state of the M layer. In a preferred embodiment, a difference in Curie temperature between the W layer and the Sw layer is suppressed to 100° C. or lower.

In addition, a domain wall coercive force and a domain wall energy density are controlled mainly by the selection of a material and an element; provided that they can be adjusted depending also on the state of a first dielectric layer for use in under coating and conditions for film formation such as a sputtering gas pressure. A Tb- or Dy-based material has large anisotropy, a large domain wall coercive force, and a large domain wall energy density while a Gd-based material has small anisotropy, a small domain wall coercive force, and a small domain wall energy density. Those physical property values can be controlled by, for example, adding an impurity. A film thickness can be controlled by a film formation rate and a film formation time.

After film formation, a magnetic field of about 15 kOe is applied by means of a permanent magnet to initialize the I layer entirely. Initialization during film formation is also permitted when productivity is taken into consideration.

Hereinafter, the present invention will be described in detail by way of specific examples. However, the present invention is not limited to the following examples without departing from its gist.

### EXAMPLE 1

A polycarbonate substrate in which guide grooves for tracking had been formed was fixed to a substrate holder in a magnetron sputtering system having a DC and RF power source. After that, the inside of a chamber was evacuated to a high vacuum of 2×10⁻⁵ Pa or less by means of a cryopump. After that, an Ar gas was introduced into the chamber while the inside of the chamber was evacuated to a vacuum. While the substrate was rotated, a target was sputtered to form each layer. Upon formation of an SiN layer, an N₂ gas was introduced in addition to an Ar gas so that DC, reactive sputtering was performed.

At first, an Ar gas and an N₂ gas were flown into the chamber, and a desired pressure was obtained through conductance adjustment. An SiN layer having a thickness of 10 nm was formed as the buffer layer 1002 on the substrate 1001. The layer had a stress of 1.1×10⁹ (dyne/cm²) on a compressive side. Next, the substrate was conveyed to another chamber, an Ar gas was introduced, and a desired pressure was obtained through conductance adjustment. An AgNdCu layer having a thickness of 100 nm was formed as the reflective layer 1003. The layer had a stress of 2.5×10⁹ (dyne/cm²) on a compressive side. After that, an Ar gas and an N₂ gas were flown into the chamber again, and a desired pressure was obtained through conductance adjustment. Then, an SiN layer having a thickness of 8 nm was formed as the second lower dielectric layer 2002. After that, the first lower dielectric layer 2001 composed of a ZnS—SiO₂ mixture and having a thickness of 6 nm was formed in another chamber.

The inclusion of an N₂ gas upon formation of a phase-change film causes nitriding or the like, so crystallization property is affected. In view of this, a dielectric layer and any other phase-change layer were formed in different chambers. After the formation of the first lower dielectric layer, the substrate was conveyed to another chamber, an Ar gas was introduced into the chamber, and a desired pressure was obtained through conductance adjustment. A GeSbTe layer having a thickness of 10 nm was formed as the recording layer 1005. After that, the first upper dielectric layer 2003 composed of a ZnS—SiO₂ mixture and having a thickness of 8 nm, and the second upper dielectric layer 2004 composed of SiN and having a thickness of 40 nm were sequentially formed. Finally, the light transmissive cover layer 1007 was laminated.

A substrate having a diameter of 120 mm and a thickness of 1.1 mm was used as the substrate 1001. Irregularities referred to as grooves and lands were formed on one main surface of the substrate on which the reflective layer 1003 was formed. The irregularities had a repeating width (track pitch) of 0.32 μm. The reflective layer 1003 had an Nd content of 0.4 at. % and a Cu content of 0.6 at. %. The light transmissive cover layer 1007 was formed by bonding a light transmissive sheet having a flat annular shape to the upper dielectric layer 1006 through an adhesive layer composed of a pressure sensitive adhesive (PSA) applied uniformly to one main surface of the light transmissive sheet in advance.

The section of the optical disk in this example thus produced was observed with a transmission electron microscope (TEM), and was compared with an initial substrate shape. Table 1 shows the results. As a result, the initial substrate shape did not change at all. In addition, no change in substrate shape was observed even after recording had been repeatedly performed 10,000 times on the optical disk under general recording conditions.

### COMPARATIVE EXAMPLE 1

A sample was produced in the same manner as in Example 1 except that the buffer layer was not formed. The section of the optical disk in this comparative example was observed in the same manner as in Example 1. Table 1 shows the results. As a result, the width of each of a convex portion and a concave portion, the taper angle of the side wall of a convex portion, and a groove depth were changed as compared to those of an initial substrate shape.

As a result, a power margin in the cross-erase property of the optical disk in this comparative example was reduced to ±10% while a power margin in the cross-erase property of the optical disk in Example 1 was ±25%.

In addition, in a durability test under a high-temperature and high-humidity environment (80° C./90%) for 1,000 hours, a jitter value deteriorated by as high as about 5% (12.3%) as compared to an initial jitter value (7.2%).

### EXAMPLE 2

The respective targets of: Si doped with B; Gd; Tb; FeCr; and CoCr were mounted on a DC magnetron sputtering system, and a polycarbonate substrate in which guide grooves for tracking had been formed was fixed to a substrate holder. After that, the inside of a chamber was evacuated to a high vacuum of 2×10⁻⁵ Pa or less by means of a cryopump. After that, an Ar gas was introduced into the chamber while the inside of the chamber was evacuated to a vacuum. While the substrate was rotated, a target was sputtered to form each layer. Upon formation of an SiN layer, an N₂ gas was introduced in addition to an Ar gas so that DC, reactive sputtering was performed.

At first, an Ar gas and an N₂ gas were flown into the chamber, and a desired pressure was obtained through conductance adjustment. An SiN layer having a thickness of 10 nm was formed as the buffer layer 3002. The layer had a stress of 3.5×10⁹ (dyne/cm²) on a compressive side. Next, the substrate was conveyed to another chamber, an Ar gas was introduced, and a desired pressure was obtained through conductance adjustment. An AlSi layer having a thickness of 100 nm was formed as the reflective heat sink layer 3003. The layer had a stress of 2.2×10⁹ (dyne/cm²) on a compressive side. After that, an Ar gas and an N₂ gas were flown into the chamber again, and a desired pressure was obtained through conductance adjustment. Then, an SiN layer having a thickness of 20 nm was formed as the first dielectric layer 3013. The inclusion of an N₂ gas upon formation of a magnetic film causes nitriding or the like, so magnetic property is affected. In view of this, a dielectric layer and any other magnetic layer were formed in different chambers. After the formation of the first dielectric layer, the substrate was conveyed to another chamber, 50 sccm of an Ar gas were introduced into the chamber, and a pressure was set to 1.0 Pa through conductance adjustment. A TbFeCoCr layer having a thickness of 50 nm and serving as the initialization layer 3004 and a TbFeCoCr layer having a thickness of 10 nm and serving as the switching layer 3005, the layers being different from each other in composition, were sequentially formed.

After that, 10 sccm of an Ar gas were introduced into the chamber, and a pressure was set to about 0.2 Pa through conductance adjustment. TbFeCoCr was formed into a film having a thickness of 20 nm and serving as the writing layer 3006. A DyFeCoCr-based material can also be used in the writing layer. TbFeCoCr was used in the present invention in view of the number of targets to be arranged on the sputtering system. Magnetic anisotropy was adjusted by reducing the pressure under which a film was formed.

Next, 35 sccm of an Ar gas were introduced into the chamber, and a pressure was set to 0.7 Pa through conductance adjustment. GdFeCoCr was formed into a film having a thickness of 30 nm and serving as the intermediate layer 3007. Next, 50 sccm of an Ar gas were introduced into the chamber, and a pressure was set to about 1.0 Pa through conductance adjustment. A TbFeCoCr layer having a thickness of 50 nm and serving as the memory layer 3008 and a TbFeCoCr layer having a thickness of 10 nm and serving as the second switching layer 3009, the layers being different from each other in composition, were sequentially formed. Next, 20 sccm of an Ar gas were introduced into the chamber, and a pressure was set to about 0.2 Pa through conductance adjustment. A TbFeCoCr film having a thickness of 14 nm was formed as the controlling layer 3010.

Next, 10 sccm of an Ar gas were introduced into the chamber, and a pressure was set to about 0.1 Pa through conductance adjustment. GdFeCoCr layers each having a thickness of 18 nm and serving as the reproduction auxiliary layer 3011 and the reproduction layer 3012, the layers being different from each other in composition ratio, were formed.

Next, an SiN layer having a thickness of 25 nm was formed as the second dielectric layer 3014 by means of DC, reactive sputtering as in the case of the formation of the first dielectric layer.

The composition ratio of each magnetic layer was controlled depending on the ratio of power to be inputted to each of the targets of Gd, Tb, FeCr, and CoCr. As described above, a composition ratio in the layer constitution (D1/D2/C/Sr/M) for realizing reproduction according to DWDD was adjusted in such a manner that each magnetic layer would have composition close to compensating composition to suppress an influence of a stray field on a domain wall displacement motion in a reproduction temperature range from the viewpoint of an improvement in reproduction property. Strictly speaking, the composition ratio was adjusted in such a manner that rare earth elements would be predominant at room temperature for the compensation of the rare earth elements and transition metal group elements each other at a temperature close to the Curie temperature of a switching layer as a reproduction temperature.

To be specific, the Curie temperature of the reproduction layer was adjusted to about 290° C. The Curie temperature of the reproduction auxiliary layer was adjusted to about 210° C. The Curie temperature of the controlling layer was adjusted to about 180° C. The Curie temperature of the second switching layer was adjusted to about 160° C. The Curie temperature of the memory layer was adjusted to about 280° C. The Curie temperature of the intermediate layer was adjusted to about 310° C. The Curie temperature of the writing layer was adjusted to about 320° C. The Curie temperature of the switching layer was adjusted to about 230° C. The Curie temperature of the initialization layer was adjusted to about 400° C.

In light intensity modulation overwrite using such medium, information is recorded by modulating the intensity of a light beam in accordance with the information. That is, a medium temperature at a portion to be irradiated with recording laser light is modulated between two kinds of temperature levels through the modulation of the laser light: a temperature level ranging from the Curie temperature Tw of the W layer to the Curie temperature Ti of the I layer (both inclusive) and a temperature level ranging from the Curie temperature Tm of the M layer to the Curie temperature Tw of the W layer (both inclusive). Overwrite is realized by orienting the magnetization of the M layer in correspondence with each temperature level.

In general, a magnetization state to be formed in the M layer upon heating to Tw is defined as a recorded state “1”, and a magnetization state to be formed upon heating to Tm is defined as an erased state “0”. The I layer is subjected to initialization polarization to an entirely erased state, and has the highest Curie temperature. The I layer always maintains an erased stated without undergoing magnetization reversal through a heating operation to the above temperature levels.

The section of the optical disk in this example thus produced was observed with a transmission electron microscope (TEM) in the same manner as in Example 1, and was compared with an initial substrate shape. Table 2 shows the results. As a result, the initial substrate shape did not change at all. In addition, no change in substrate shape was observed even after recording had been repeatedly performed 100,000 times on the optical disk under general recording conditions.

### COMPARATIVE EXAMPLE 2

A sample was produced in the same manner as in Example 2 except that the buffer layer was not formed. The section of the optical disk in this comparative example was observed in the same manner as in Example 1. Table 2 shows the results. As a result, the width of each of a convex portion and a concave portion, the taper angle of the side wall of a convex portion, and a groove depth were changed as compared to those of an initial substrate shape.

Thus, the state of adhesion of a film to the substrate changed, and thermal structure of the optical disk and a volume balance between the respective magnetic films were lost. As a result, a DTE process according to light intensity modulation was adversely affected. To be more specific, the balance of an exchange interaction between the memory layer and the writing layer was lost, so an erasing operation was in an insufficient state. As a result, unerased data occurred to make it impossible to perform overwrite.

### EXAMPLE 3

A polycarbonate substrate in which pit trains had been formed at a predetermined pitch in correspondence with recording information was fixed to a substrate holder in a DC magnetron sputtering system. The pit trains were provided to form a spiral track around a central axis on one main surface. After that, the inside of a chamber was evacuated to a high vacuum of 2×10⁻⁵ Pa or less by means of a cryopump. A pit corresponding to the recording information in an optical disk of this example was a pit projecting toward the side on which light to be applied was incident.

After that, an Ar gas was introduced into the chamber while the inside of the chamber was evacuated to a vacuum. While the substrate was rotated, a target was sputtered to form each layer. Upon formation of an SiN layer, an N₂ gas was introduced in addition to an Ar gas so that DC, reactive sputtering was performed.

At first, an Ar gas and an N₂ gas were flown into the chamber, and a desired pressure was obtained through conductance adjustment. An SiN layer having a thickness of 10 nm was formed as a buffer layer. The layer had a stress of 3.5×10⁹ (dyne/cm²) on a compressive side. Next, the substrate was conveyed to another chamber, an Ar gas was introduced, and a desired pressure was obtained through conductance adjustment. An Al layer having a thickness of 70 nm was formed as a reflective layer. The layer had a stress of 2.2×10⁹ (dyne/cm²) on a compressive side. After that, a UV curable resin was applied by means of, for example, spin coating, and was irradiated with ultraviolet light to be cured, whereby a light transmissive cover having a thickness of, for example, 0.1 mm was formed. Thus, the optical disk of this example was formed.

The section of the optical disk in this example was observed in the same manner as in Example 1. Table 3 shows the results. As a result, an initial substrate shape did not change at all.

In addition, light to be applied was converged on the optical disk in this example by means of an objective lens from the side of the light transmissive cover so that recording information was read from the disk. Here, the wavelength λ of the light to be applied was 405 nm, and the numerical aperture NA of the objective lens was 0.85.

As a result, the stable signal reproduction of the recording information was attained by means of the intensity of reflected light obtained by modulating the light to be applied with a pit.

The foregoing shows that a read only type optical disk having good and stable reproduction signal property can be obtained according to the present invention. The recording information surface (based on pit trains) of the optical disk according to the present invention is not limited to a single layer constitution. For example, two substrates each having recording information and each having pits formed therein may be bonded to each other with their light transmissive protective cover sides facing outward.

Alternatively, a resin layer composed of, for example, a UV curable resin is formed on, for example, the above-described recording information surface based on pit trains, and a pit is formed on the resultant by means of a photopolymerization method (2P method) to provide a multilayer structure.

### COMPARATIVE EXAMPLE 3

A sample was produced in the same manner as in Example 3 except that the buffer layer was not formed. The section of the optical disk in this comparative example was observed in the same manner as in Example 1. Table 3 shows the results. As a result, the width and the length of a pit, the taper angle of the side wall of a pit, and a pit height were changed as compared to those of an initial pit shape.

As a result, the asymmetry of an HF signal of the optical disk in this comparative example deteriorated up to 10% while the asymmetry of an HF signal of the optical disk in Example 3 was 2%. In addition, the degree of modulation of an HF signal of the shortest pit (2T: 150 nm) with respect to the longest pit (8T) deteriorated up to 0.008 in the optical disk in this comparative example while the degree of modulation of an HF signal of the shortest pit with respect to the longest pit was 0.025 in the optical disk in Example 3.

TABLE 1

| | | | | Taper angle | |
|---|---|---|---|---|---|
| | | Convex | Concave | of side wall | |
| | | portion | portion | of convex | Groove |
| | | width | width | portion | depth |
| | | (nm) | (nm) | (deg.) | (nm) |
| Initial stage | | 140 | 130 | 30 | 30 |
| After | Example 1 | 140 | 130 | 30 | 30 |
| formation | Comparative | 95 | 185 | 40 | 35 |
| of | example 1 | | | | |
| reflective | | | | | |
| layer | | | | | |

TABLE 2

| | | | | Taper angle | |
|---|---|---|---|---|---|
| | | Convex | Concave | of side wall | |
| | | portion | portion | of convex | Groove |
| | | width | width | portion | depth |
| | | (nm) | (nm) | (deg.) | (nm) |
| Initial stage | | 320 | 275 | 60 | 80 |
| After | Example 2 | 320 | 275 | 60 | 80 |
| formation | Comparative | 230 | 380 | 70 | 83 |
| of | example 2 | | | | |
| reflective | | | | | |
| layer | | | | | |

TABLE 3

| | | | | Taper angle | |
|---|---|---|---|---|---|
| | | Pit | Pit | of side wall | Pit |
| | | width | length | of pit | height |
| | | (nm) | (nm) | (deg.) | (nm) |
| Initial stage | | 120 | 150 | 70 | 80 |
| After | Example 3 | 120 | 150 | 70 | 80 |
| formation | Comparative | 84 | 100 | 80 | 85 |
| of | example 3 | | | | |
| reflective | | | | | |
| layer | | | | | |

This application claims priority from Japanese Patent Application No. 2005-159058 filed on May 31, 2005, which is hereby incorporated by reference herein.

What is claimed is:

1. An optical disk comprising:
a substrate;
a reflective layer laminated on the substrate;
a recording layer laminated on the reflective layer; and
a buffer layer formed between the substrate and the reflective layer, the buffer layer having a thermal conductivity lower than that of the reflective layer.

2. The optical disk according to claim 1, wherein the buffer layer comprises at least one dielectric material selected from the group consisting of SiO₂, Ta₂O₅, SiN, and SiC.

3. The optical disk according to claim 1, wherein a direction in which the optical disk is irradiated with laser comprises a direction from the recording layer to the substrate.
